(19) United States
(12) Patent Application Publication
(10) Pub. No.: US 2026/0126746 A1
(43) Pub. Date: May 7, 2026

(54) IMAGE FORMING DEVICE, METHOD FOR CONTROLLING IMAGE FORMING DEVICE, AND STORAGE MEDIUM

(71) Applicant: CANON KABUSHIKI KAISHA, Tokyo (JP)

(72) Inventor: HIROSHI OYA, Tokyo (JP)

(21) Appl. No.: 19/371,600

(22) Filed: Oct. 28, 2025

(30) Foreign Application Priority Data
Nov. 1, 2024 (JP) 2024-192849

(51) Int. Cl. G03G 15/00

(52) U.S. Cl. CPC G03G 15/556

(57) ABSTRACT

A method for controlling an image forming device including a recording material storage unit with a storage unit includes acquiring, from the storage unit, the number of devices in which the recording material storage unit has been installed and providing a predetermined notification based on the acquired number of devices.

### BACKGROUND

### Field of the Technology

The present disclosure relates to an image forming device, a method for controlling an image forming device, and a storage medium.

### Description of the Related Art

Existing image forming devices include a replaceable recording material storage unit, such as a toner cartridge. The recording material storage unit deteriorates over time or becomes unusable when the recording material contained in the recording material storage unit is completely consumed.

To detect the end of service life of a recording material storage unit, some image forming devices have a function to acquire, for example, the remaining amount information of a consumable (for example, a toner cartridge) of the image forming device from the consumable and display the acquired information.

In addition, some image forming devices estimate the remaining amount of consumable material contained in the recording material storage unit for each of the numbers of days of use and estimate the number of remaining usable days (hereinafter referred to as “remaining days”) and display the information.

However, even when the same data is printed, different properties of recording materials may result in different consumption amounts of the recording material. If a plurality of recording material storage units from different manufacturers are installed and used, obtained training data may not be correct and, therefore, the accuracy of estimation of the remaining days may be reduced.

Japanese Patent Laid-Open No. 2020-071396 describes a method for updating the training data only when a specific manufacturer's recording material storage unit is installed.

If a particular manufacturer's recording material storage unit is shared by a plurality of image forming devices and is used in a shared manner, sufficient training data may not be acquired, and the accuracy of estimation of the remaining days of the recording material storage unit may deteriorate. As a result, users cannot correctly obtain the remaining days.

### SUMMARY

According to an aspect of the present disclosure, an image forming device includes a recording material storage unit that includes a storage unit, at least one memory that stores a program, and at least one processor that causes, by executing the program, the image forming device to acquire, from the storage unit, a number of devices in which the recording material storage unit has been installed and provide a predetermined notification based on the acquired number of devices.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the overall configuration of a system according to the present disclosure.

FIG. 2 illustrates an example of a cross-sectional view of an image forming device according to the present disclosure.

FIG. 3 illustrates an example of the hardware configuration of the image forming device according to the present disclosure.

FIG. 4 illustrates an example of the hardware configuration of a device management server according to the present disclosure.

FIG. 5 illustrates an example of cartridge management information stored in a cartridge memory according to a first embodiment.

FIG. 6 illustrates a flowchart of a cartridge error determination process performed by the image forming device according to the first embodiment.

FIG. 7A illustrates an example of a notification screen according to the first embodiment.

FIG. 7B illustrates an example of the notification screen according to the first embodiment.

FIG. 7C illustrates an example of the notification screen according to the first embodiment.

FIG. 8A illustrates an example of information to be notified to the device management server according to the first embodiment.

FIG. 8B illustrates an example of information to be notified to the device management server according to the first embodiment.

FIG. 8C illustrates an example of information to be notified to the device management server according to the first embodiment.

FIG. 9 illustrates an example of cartridge management information stored in a cartridge memory according to a second embodiment.

FIG. 10 illustrates a flowchart of a cartridge error determination process performed by the image forming device according to the second embodiment.

FIG. 11 illustrates an example of a screen that notifies a user that an installed device count exceeded error occurs, according to the second embodiment.

FIG. 12 illustrates an example of information to be notified to a device management server according to the second embodiment.

### DESCRIPTION OF THE EMBODIMENTS

Embodiments are described in detail below with reference to the accompanying drawings. The following description of example embodiments is in no way intended to limit the present disclosure according to the appended claims. All of the features and the combinations thereof described in the embodiments are not necessarily deemed to be essential to every embodiment of the present disclosure.

The present embodiment is described below with reference to a color electrophotographic laser printer as an example of an image forming device. The consumable is toner, which is an example of a recording material, and a toner cartridge that contains the toner and includes a developing device and a photoconductive drum integrated with each other is an example of a recording material storage unit.

According to the present embodiment, a single function peripheral (SFP) is used as an example, but the image forming device may also be a multi-function peripheral (MFP).

The image forming device may be an inkjet printer instead of an electrophotographic printer.

According to the present embodiment, a description is provided with reference to, as an example of the recording material storage unit, a toner cartridge having a configuration in which the developing device and the photoconductive drum are integrated with each other, but the recording material storage unit may be a cartridge or toner bottle having a configuration in which the developing device and the photoconductive drum are separated from each other. The recording material storage unit may also be an ink cartridge.

Hereafter, the toner cartridge is simply referred to as a “cartridge.”

### First Embodiment

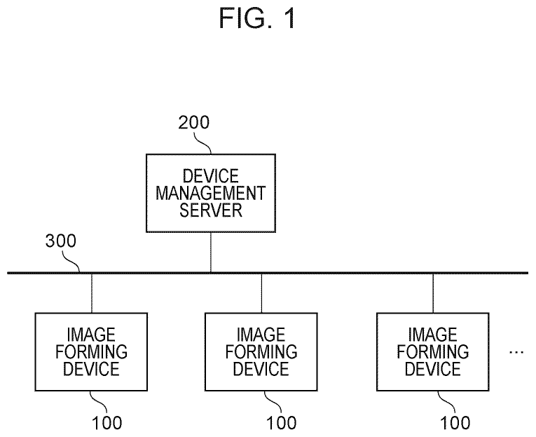

FIG. 1 is a block diagram of the overall configuration of a processing system according to the first embodiment. The processing system includes an image forming device 100 and a device management server 200, which are connected to each other via a communication network 300 (for example, the Internet).

The image forming device 100 stores use state information and various setting information of the image forming device 100 in a storage 114.

The use state information includes information about a cartridge installation log. When a request to acquire such information is received from the device management server 200 via the communication network 300, the information is sent to the device management server 200 in response to the request.

The device management server 200 stores and manages the use state information and the various setting information received from a plurality of image forming devices 100.

The communication network 300 may be configured to be wirelessly connected to an access point (not illustrated), as long as the network configuration can transmit image data.

Communication between the image forming device 100 and the device management server 200 is performed using a communication protocol, such as Hypertext Transfer Protocol (hereinafter referred to as HTTP). A well-known control method for HTTP is used.

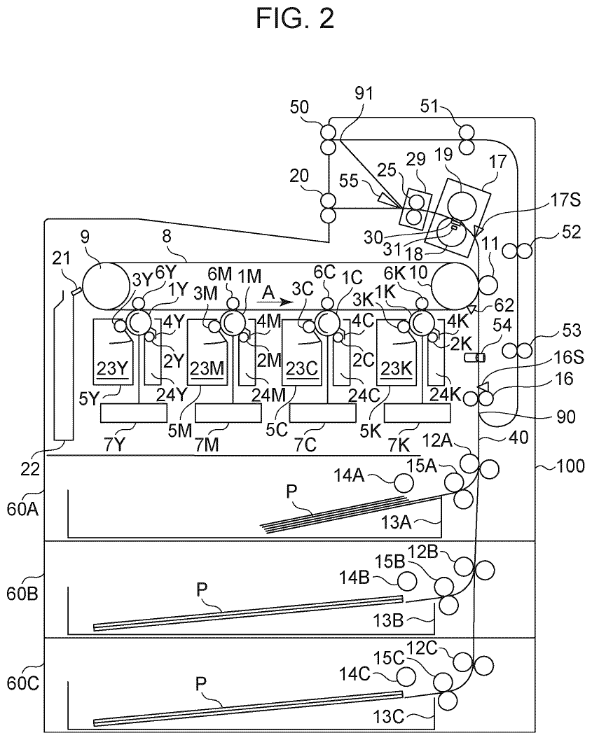

FIG. 2 is a cross-sectional view of the image forming device 100 according to the present embodiment.

The image forming device 100 includes cartridges (process cartridges) 5Y, 5M, 5C, and 5K that are removable from the image forming device 100. “Y” represents yellow, “M” represents magenta, “C” represents cyan, and “K” represents black. The four cartridges 5Y, 5M, 5C, and 5K have the same structure, but contain toner (developing agents) of different colors. That is, the four cartridges differ from one another in that each is used to form an image using Y, M, C, and K toner (a developing agent). Hereinafter, the reference symbols Y, M, C, and K are omitted from the description, except when a particular cartridge is described.

Installation and uninstallation of each of the cartridges 5 can be detected by an installation/uninstallation detection sensor (not illustrated). Each of the cartridges 5 includes a toner container 23, a photoconductive drum 1 (an image bearing member) serving as a photoconductive member, a charging roller 2, a developing roller 3 (the developing device), a cleaning blade 4 (a photoconductive member cleaning unit), and a collected toner container 24.

Each of the cartridges 5 includes a toner remaining amount detection sensor (not illustrated) and, thus, can acquire the toner remaining amount from the sensor. Each of the cartridges 5 includes a memory, which is an example of a storage unit, and functions as a recording material storage unit with a storage unit. Each of the cartridges 5 can store information about the cartridge 5. An exposure device 7 is disposed below the cartridge 5 and exposes the photoconductive drum 1 based on an image signal.

The photoconductive drum 1 is uniformly charged to predetermined polarity and potential by the charging roller 2 during its rotation process. The photoconductive drum 1 is subjected to image exposure by the exposure device 7. This results in electrostatic latent images each corresponding to one of first to fourth color component images (Y, M, C, and K component images) of the target color image being formed on the photoconductive drums 1.

The charging roller 2 is rotationally driven by the rotation of the photoconductive drum 1. According to the present embodiment, the exposure device 7 is a polygon scanner using a laser diode and forms an electrostatic latent image on the photoconductive drum 1 by using a laser beam modulated based on image information. The laser exposure writing in the main-scanning direction (a direction perpendicular to a print paper conveying direction) is performed for each of scanning lines by being delayed from a position signal (BD signal) in the polygon scanner by a predetermined amount of time. When an image is formed on print paper (a sheet), writing is performed in the sub-scanning direction (the print paper conveying direction) at predetermined intervals between the cartridges. In this way, in the first to fourth cartridges Y, M, C, and K, exposure is always performed on the photoconductive drums 1 at the same position to minimize color shift.

The electrostatic latent images formed on the photoconductive drums 1 are developed by the developing rollers 3 of the first to fourth cartridges Y, M, C, and K. Toner of each color adheres to the electrostatic latent image on the photoconductive drum 1 via the developing roller 3 to develop the electrostatic latent image into a toner image. The toner in each of the developing devices is negatively charged non-magnetic monocomponent toner, and the electrostatic latent image is developed by a non-magnetic monocomponent contact developing method. A developing bias is applied to the developing roller 3 by a developing bias power supply (not illustrated) to develop the image.

An intermediate belt unit includes an intermediate transfer belt 8, a drive roller 9, and a secondary transfer counter roller 10. Each of primary transfer rollers 6 is disposed inside of the intermediate transfer belt 8 to face one of the photoconductive drums 1, and a primary transfer bias of positive polarity is applied by a primary transfer bias power supply (not illustrated). The intermediate transfer belt 8 is rotated by the drive roller 9 driven by a motor (not illustrated) and, thus, the secondary transfer counter roller 10 is rotationally driven. Each of the photoconductive drums 1 rotates in the direction of an arrow, the intermediate transfer belt 8 rotates in the direction of arrow A, and a primary transfer bias of positive polarity is applied to the primary transfer roller 6. As a result, the toner images on the photoconductive drums 1 are primary transferred onto the intermediate transfer belt 8 (onto the belt) sequentially, starting with the toner image on the photoconductive drum 1Y. The toner images of the four colors in a superimposed state are then conveyed to a secondary transfer roller 11. A density sensor 62 detects the toner density of the four color toner images that have been primary transferred onto the intermediate transfer belt 8.

The cleaning blade 4 of the photoconductive drum 1 is in pressure contact with the photoconductive drum 1 to remove residual toner that have not been transferred to the intermediate transfer belt 8 and have remained on a surface of the photoconductive drum 1 and other residual materials on the photoconductive drum 1 (the photoconductive member). Some visible images are not transferred to the print paper P at the position of the secondary transfer roller 11 and remain on the intermediate transfer belt 8. Since the visible images remaining on the intermediate transfer belt 8 is not necessary, the images are removed through a cleaning operation. In the cleaning operation, the unnecessary visible images are conveyed by the intermediate transfer belt 8 to the cleaning blade 21, scraped by the cleaning blade 21, and are collected by a collected toner container 22. Thus, the visible images are removed.

The print paper P is stored in feed cassettes (13A, 13B, 13C) of the paper feeding units (60A, 60B, 60C), respectively. The print paper P is conveyed to the secondary transfer roller 11 by pick-up rollers (14A, 14B, 14C), feed rollers (15A, 15B, 15C), pull-out roller pairs (12A, 12B, 12C), and a registration roller pair 16. The paper feeding unit 60A is a standard feeder integrated with the image forming device 100, while the paper feeding units 60B and 60C are optional feeders that can be mounted or dismounted as needed.

To transfer the four-color toner image on the intermediate transfer belt 8 to the conveyed print paper P (hereinafter, the operation is referred to as secondary transfer), a bias of positive polarity is applied to the secondary transfer roller 11.

A paper type determination sensor 54 is provided downstream of the registration roller pair 16 at a merging section where the conveyance paths from paper feeding ports merge. When the paper type determination sensor 54 determines the type of fed print paper P, a paper feed motor (not illustrated) is halted at the timing the leading edge of the print paper P reliably reaches the position of the paper type determination sensor 54 after the registration sensor 16S detects the leading edge of the print paper P. After the paper feeding motor is halted, the image forming device 100 identifies the type of the print paper P using the paper type determination sensor 54.

The print paper P subjected to toner image transfer is conveyed to the fixing unit 17. The fixing unit 17 is a film-heating fixing unit including a fixing roller 18 and a pressure roller 19 that is in pressure contact with the fixing roller 18. The fixing roller 18 incorporates a fixing heater 30 and a fixing thermistor 31 that measures the temperature of the fixing heater 30. The toner image is fixed by heating and pressurizing the print paper P. The print paper P having the toner image fixed thereon is conveyed by a curl correcting roller pair 25 of a curl correcting mechanism 29 and is discharged external to the image forming device 100 as an image forming product (such as printed paper).

When the print paper P that has passed through the fixing unit 17 is not output external to the image forming device 100 and printing is to be performed on a second side of the print paper P, the print paper P that has passed through the fixing unit 17 is conveyed in a direction toward a reversing point 91. A duplex flapper 55 can switch a print paper conveying direction between a discharge direction and a reversing unit direction. When duplex printing is performed, the direction of the duplex flapper 55 is switched to the reversing unit direction before the leading edge of the print paper P having an image formed on the first side reaches the duplex flapper 55. After the print paper P passes through the reversing point 91, a reversing roller pair 50 conveys the paper P in the discharge direction external to the image forming device 100. After the trailing edge of the print paper P passes through the reversing point 91, the reversing roller pair 50 is temporarily stopped while the print paper is still at the position of the reversing roller pair 50. Thereafter, the reversing roller pair 50 is rotated in the reverse rotation direction to convey the print paper P in the direction of a duplex conveyance path. In the duplex conveyance path, the print paper P is conveyed by a duplex conveyance first roller pair 51, a duplex conveyance second roller pair 52, and a duplex conveyance third roller pair 53.

The duplex conveyance path merges with the conveyance path extending between the feed roller pair 15 and the registration roller pair 16 at a merging point 90. The print paper P, which has been flipped front to back, is conveyed to the secondary transfer roller 11 by the registration roller pair 16. The four-color toner image on the intermediate transfer belt 8 is then transferred to the second side of the print paper P.

The toner image transferred to the second side is fixed by the fixing unit 17.

By switching the direction of the duplex flapper 55 to the discharge direction external to the image forming device 100, the print paper P having images formed on both sides is output from the image forming device 100.

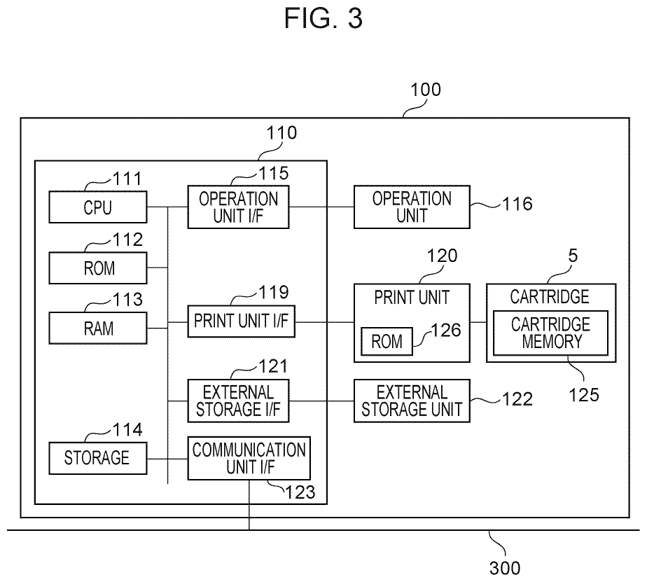

FIG. 3 is a block diagram of an example of the hardware configuration of the image forming device 100.

A control unit 110 that includes a central processing unit (CPU) 111 controls all the operations performed by the image forming device 100.

The CPU 111 reads a control program stored in a read only memory (ROM) 112 or the storage 114 and performs various control operations, such as a printing control operation and an information display operation on an operation unit 116.

The ROM 112 stores control programs that can be executed by the CPU 111. The ROM 112 also stores a boot program and font data.

A random-access memory (RAM) 113 is the main memory of the CPU 111 and is used as a work area and a temporary storage area for loading the various control programs stored in the ROM 112 and the storage 114.

The storage 114 stores image data, print data, various programs, and various setting information. According to the present embodiment, the training data used to estimate the remaining days of the cartridge 5 is also stored in the storage 114. According to the present embodiment, a flash memory is used as the storage 114. However, an auxiliary storage device, such as a solid-state drive (SSD), a hard disk drive (HDD), or an embedded multimedia card (eMMC), may be used.

While the image forming device 100 is described with reference to the configuration including one CPU 111 that performs each of the processes illustrated in a flowchart described below using one memory (the RAM 113), the image forming device 100 may have another configuration.

For example, a plurality of CPUs, RAMs, ROMs, and storages may collaborate with one another to perform the processes illustrated in the flowchart described below. In addition, a hardware circuit, such as an application specific integrated circuit (ASIC) or a field programmable gate array (FPGA), may be used to perform some of the processes.

An operation unit interface (I/F) 115 connects the operation unit 116 to the control unit 110.

The operation unit 116 includes a touch panel and hard keys. The touch panel includes a liquid crystal display unit and a touch panel sheet bonded to the liquid crystal display unit. The operation unit 116 displays information for a user via the touch panel and receives an input from the user via the touch panel and hard keys.

A print unit I/F 119 connects a print unit 120 to the control unit 110. The CPU 111 sends image data to be printed (printing target image data) to the print unit 120 via the print unit I/F 119 and causes the print unit 120 to print an image.

The CPU 111 can access information in a cartridge memory 125 included in the cartridge 5 via the print unit I/F 119 and the print unit 120. The cartridge memory 125 stores, for example, page count information indicating the number of sheets on which images have been formed using the cartridge 5, toner remaining amount information indicating the remaining amount of toner, and information about the life of the cartridge 5. According to the present embodiment, the cartridge memory 125 also stores information regarding the number of the image forming devices 100 in which the cartridge 5 has been installed (hereinafter referred to as “installed device count information 509”). The installed device count information 509 is described in more detail below.

The print unit 120 prints an image on print paper fed from the feed cassette 13 using toner contained in the cartridge 5. The print unit 120 includes a CPU (not illustrated), which stores, in the RAM 113, the condition information of the print unit, including the operation condition, error information, and information about the cartridge 5. The CPU 111 of the control unit 110 refers to the condition information stored in the RAM 113.

An external storage I/F 121 connects an external storage apparatus 122 to the control unit 110. The CPU 111 stores image data in the external storage apparatus 122 via the external storage I/F 121.

According to the present embodiment, a USB interface is used as the external storage I/F 121, and a USB memory is used as the external storage apparatus 122. However, an SD card, for example, may be used as the external storage apparatus 122.

The control unit 110 is connected to the communication network 300 using the communication unit I/F 123 and can communicate with the device management server 200 and an information processing device (not illustrated) via the communication network 300. Printing can be performed by sending image data from the information processing device (not illustrated) to the image forming device 100. The information processing device (not illustrated) can be a personal computer (PC) or an information processing terminal, such as a tablet.

The communication unit I/F 123 can transmit various types of information in the image forming device to the device management server 200. Examples of the various types of information in the image forming device include various setting information regarding the operations performed by the image forming device 100 and use state information including the number of sheets printed by the image forming device 100, error information, and information regarding the cartridge 5.

The communication unit I/F 123 receives, from the device management server 200, a request for referencing various types of information in the image forming device or changing the setting information. The communication unit I/F 123 then reads the various types of information in the storage 114 or changes the setting information.

Transmission of various types of information to the device management server 200 and reception of a request for changing the setting information from the device management server 200 are performed by a web server application that processes HTTP requests.

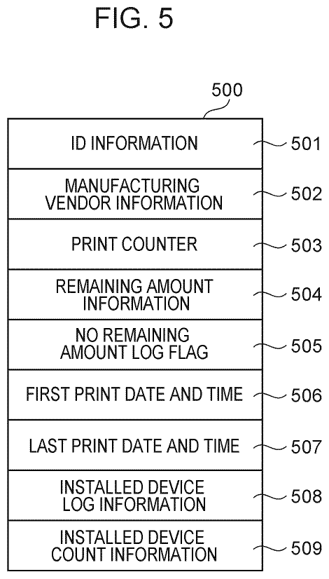

The cartridge memory 125 is a nonvolatile storage medium included in the cartridge 5. The cartridge memory 125 stores information about the cartridge 5. The details of the information stored in the cartridge memory 125 are illustrated in FIG. 5. According to the present embodiment, the information about the cartridge 5 is acquired by the print unit 120, which sends the acquired information to the CPU 111 and the storage 114 via the print unit I/F 119. However, the CPU 111 of the control unit 110 may directly acquire the information about the cartridge 5.

The ROM 126 stores information used only by the print unit 120. Examples of the information include, for example, adjustment values for printing and color shift correction performed by the print unit 120. According to the present embodiment, a print device identifier is stored in the ROM 126. The print device identifier is a unique value assigned to each of the image forming devices 100 and can be used to identify the image forming device 100. That is, the print device identifier can be used as identification information to identify the image forming device 100.

According to the present embodiment, the image forming device 100 has a function to estimate the remaining amount of the consumable material contained in the recording material storage unit for each of for each of the numbers of days of use and estimate and display the remaining usable days (hereinafter referred to as the remaining days). To estimate and display the remaining days, the method described in Japanese Patent Laid-Open No. 2020-071396 can be employed, for example.

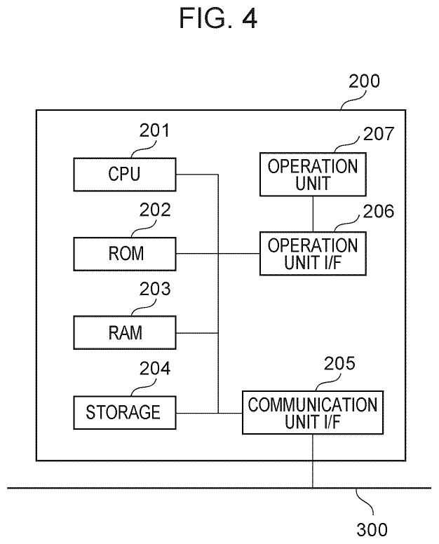

FIG. 4 illustrates an example of the hardware configuration of the device management server 200.

The CPU 201 performs processing, such as an arithmetic operation, determination, and control of data and an instruction based on the programs stored in a ROM 202, a RAM 203, and a storage 204.

The RAM 203 is used as a temporary storage area for the CPU 201 to perform a variety of processes. The storage 204 stores an operating system (OS), application software, a program, and a like. In addition, the storage 204 stores cartridge alarm information 800 (described below) and various types of setting information (not illustrated) of the image forming device 100.

A communication unit I/F 205 uses a wireless LAN compatible with a standard, such as IEEE802.11a, or a wired LAN to exchange data with devices on the same network or the Internet using a protocol, such as TCP/IP.

An operation unit I/F 206 connects an operation unit 207 to the CPU 201.

The operation unit 207 includes a keyboard and a mouse. The operation unit 207 is used to input a reference instruction to refer to various types of information collected from the image forming device 100 and a change instruction to change various setting information of the image forming device 100.

The present embodiment is not limited to the configuration illustrated in FIG. 4. A configuration that achieves the functions of the device management server 200 using a cloud server may be employed.

The device management server 200 need not be configured using a single server. That is, the functions provided by the device management server 200 may be achieved using a server system including a plurality of servers. In this way, it is desirable that information be collected from various types of image forming devices 100 located globally.

FIG. 5 illustrates an example of cartridge management information 500 stored in the cartridge memory 125 of the cartridge 5.

ID information 501 is a unique ID to identify each of the cartridges 5. A unique ID is uniquely assigned to each cartridge 5. According to the present embodiment, a serial number is used as an example of the unique ID.

Manufacturing vendor information 502 is information indicating the vendor of the cartridge 5.

The print counter 503 is a cumulative counter of the number of sheets printed using the cartridge 5 installed in the image forming device 100.

The remaining amount information 504 is the remaining amount information of the cartridge 5 and indicates the toner remaining amount detected by the toner remaining amount detection sensor (not illustrated). The life of the cartridge 5 depends on the toner remaining amount, on the degree of wear of the parts that constitute the cartridge 5 (for example, the photoconductive drum 1, the charging roller 2, the developing roller 3, and the cleaning blade 4), and the amount of toner collected in the collected toner container 24. The overall life of the cartridge 5 may be calculated while accounting for all or some of the above-described factors. The calculated value may be stored as the remaining amount information 504. In either case, the remaining amount information 504 of zero (that is, the end of life of the cartridge 5) indicates that the cartridge 5 is to be replaced. A “no remaining amount log flag” 505 is information indicating whether the cartridge 5 has a log indicating that the CPU 111 has determined that the cartridge 5 entered a “no remaining amount” mode (ON) or has not (OFF) when the remaining amount information 504 becomes zero (reaches the end of life). Once the no remaining amount log flag 505 is set to ON, the no remaining amount log flag 505 is never set to OFF.

First print date and time information 506 indicates the date and time when the cartridge 5 is first used for printing by any of the image forming devices 100. Once the first print date and time is set, it is never updated.

The last print date and time information 507 indicates the date and time the cartridge 5 is last used for printing performed by any of the image forming devices 100. The last print date and time information 507 is updated to a new date and time in a timely manner.

Installed device log information 508 indicates the log of the image forming device 100 in which the cartridge 5 is installed. According to the present embodiment, the print device identifier stored in the ROM 126 is used as the installed device log information 508. That is, when the cartridge 5 is installed, the print unit 120 reads the installed device log information 508 from the cartridge memory 125. The CPU 111 then compares the print device identifier contained in the installed device log information 508 with the print device identifier stored in the ROM 126. Based on the comparison, the print device identifier stored in the ROM 126 may not match any of the print device identifiers included in the installed device log information 508. In such a case, the CPU 111 adds the print device identifier stored in the ROM 126 to the installed device log information 508 in the cartridge memory 125. The same control may be performed using a device serial number of the image forming device 100 stored in the storage 114 as the information stored in the installed device log information 508 instead of using the print device identifier stored in the ROM 126.

The installed device count information 509 is information indicating the number of image forming devices 100 that the cartridge 5 has been installed in. The number of image forming devices 100 is the same as the number of print device identifiers stored in the installed device log information 508. According to the present embodiment, the value of the installed device count information 509 is increased by one when the print unit 120 adds a print device identifier to the installed device log information 508.

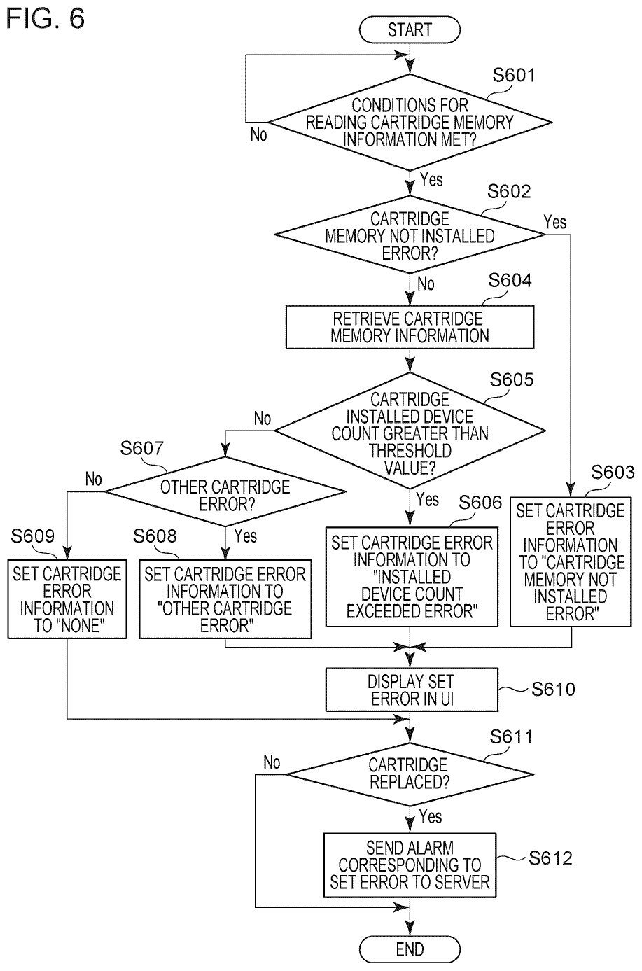

FIG. 6 illustrates a flowchart of a cartridge error determination process performed by the image forming device 100 according to the present embodiment. The process is performed when the cartridge 5 is installed in a plurality of image forming devices 100. The process is performed by the CPU 111 of the image forming device 100 by loading a program stored in the ROM 112 into the RAM 113 and executing the loaded program.

In S601, the CPU 111 determines whether the conditions for reading the cartridge memory information are met. The information in the cartridge memory 125 needs to be read when the cartridge status is changed, such as when the cartridge is likely to have been replaced.

One example of a condition for reading the cartridge memory information is that the power of the image forming device 100 is turned ON. Another example of a condition for reading the cartridge memory information is that the image forming device 100 returns from an energy-saving state (a sleep mode). Still another example of a condition for reading the cartridge memory information is that a cover (not illustrated) that is opened and closed when the cartridge 5 is installed in or uninstalled from the image forming device 100 is opened and closed. Still yet another example of a condition for reading the cartridge memory information is that a status change of the cartridge 5 is detected, like the cartridge 5 being installed in the image forming device 100.

If, in S601, it is determined that the condition is not met, the CPU 111 repeats the process in S601 until the condition is met. If, in S601, it is determined that the condition for reading the cartridge memory information is met, the processing performed by the CPU 111 proceeds to S602.

In S602, the CPU 111 determines whether a “cartridge memory not installed” error has occurred. According to the present embodiment, the “cartridge memory not installed” error is detected when the print unit 120 fails to read the information in the cartridge memory 125. Upon receipt of a “cartridge memory not installed” error message from the print unit 120, the CPU 111 determines that a “cartridge memory not installed” error has occurred. The “cartridge memory not installed” error is detected when the print unit 120 is unable to access the cartridge memory even though an installation detection sensor (not illustrated) determines that the cartridge 5 is installed. This situation occurs, for example, when the cartridge memory 125 is not mounted in the cartridge 5.

If, in S602, it is determined that a “cartridge memory not installed” error has occurred, the CPU 111 sets the cartridge error information in the RAM 113 to “cartridge memory not installed error” in S603. In this case, the cartridge error information has the same value as consumable error type information 805 (described below).

If, in S602, it is determined that a “cartridge memory not installed” error has not occurred, the process proceeds to S604.

In S604, the CPU 111 instructs the print unit 120 to retrieve the cartridge management information 500 via the print unit I/F 119 and the CPU 111 receives the cartridge management information 500 retrieved from the cartridge memory 125 by the print unit 120.

In S605, the CPU 111 refers to the installed device count information 509 contained in the retrieved cartridge management information 500 and determines whether the number of the image forming devices 100 in which the cartridge 5 has been installed so far is greater than a predetermined threshold value.

According to the present embodiment, the predetermined threshold value is 2. That is, if the installed device count information 509 is 3 or greater, it is determined that the number of the image forming devices 100 is greater than the predetermined threshold value. In terms of only the estimation accuracy of the remaining days, it is desirable that the threshold value be 1. However, presume, for example, that there is a user who concurrently uses a plurality of image forming devices 100 of the same model. If the cartridge 5 in an image forming device A reaches the end of its service life, the user may share a cartridge 5 installed in an image forming device B between the two mage forming devices until the user purchases a new cartridge 5. Therefore, according to the present embodiment, to enable one cartridge to be shared by two image forming devices 100 for the convenience of the user and avoid the occurrence of error, the threshold value is set to 2. While the present embodiment is described with reference to the predetermined threshold value being a fixed value stored in the storage 114, the user may change the threshold value via, for example, the operation unit 116. Alternatively, the threshold value may be changed in response to an instruction from a PC connected to the image forming device 100 via a network.

If, in S605, it is determined that the number of image forming devices 100 in which the cartridge 5 has been installed so far is greater than the predetermined threshold value, the CPU 111 sets, in S606, the cartridge error information in the RAM 113 to “installed device count exceeded error”.

If, in S605, it is determined that the number of image forming devices 100 in which the cartridge 5 has been installed so far is less than or equal to the predetermined threshold value, then the CPU 111 determines, in S607, whether any other cartridge error has occurred. According to the present embodiment, the other cartridge errors are “unsupported cartridge”, “life-expired cartridge,” and the like. However, the other cartridge errors are not limited thereto, and may be any errors related to a cartridge. According to the present embodiment, for simplicity, all the other errors are classified as “other cartridge errors.” It is desirable to classify the errors into more detailed categories (classify each of the errors into different more detailed errors) and display the more detailed error via the UI or the like.

If, in S607, it is determined that the cartridge 5 has experienced “other cartridge error,” then the CPU 111 sets, in S608, the cartridge error information in the RAM 113 to “other cartridge error”.

If, in S607, it is determined that cartridge 5 has not experienced “other cartridge error,” that is, there is no error, then the CPU 111 sets, in S609, the cartridge error information in the RAM 113 to “none.”

If the cartridge error information in the RAM 113 is not “none,” the CPU 111 displays, in S610, an error screen corresponding to the set error on the operation unit 116. This can provide a reminder to the user.

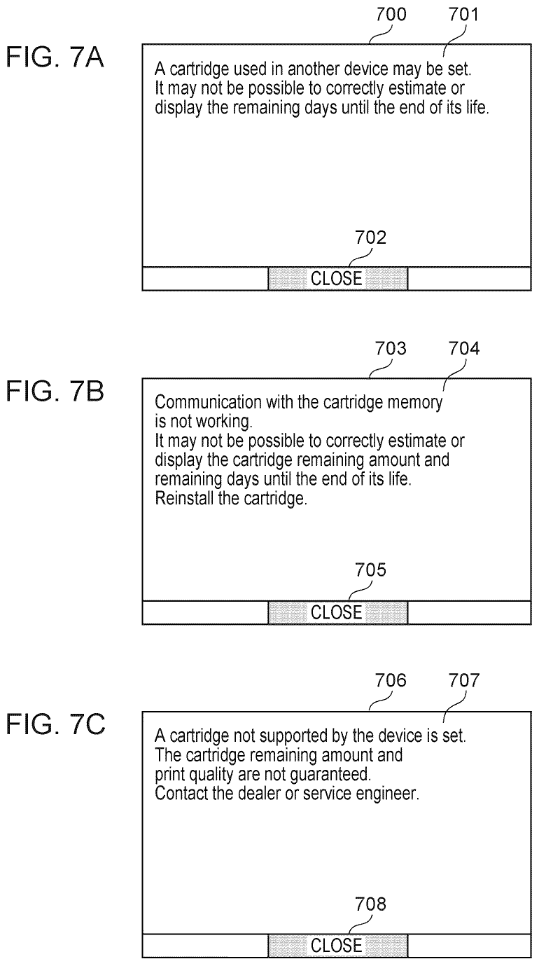

An example of an error screen displayed on the operation unit 116 is illustrated in FIG. 7A when, in step S610, the cartridge error information is “installed device count exceeded error.”

FIG. 7A illustrates the example of an error screen displayed when an “installed device count exceeded error” occurs according to the present embodiment. While the present embodiment is described with reference to error screens displayed on the liquid crystal display unit of the touch panel of the operation unit 116, the error screens may be displayed on another display unit.

An installed device count exceeded error screen 700 includes a status display field 701 and a close button 702. The status display field 701 is a field that displays the cause and description of the error that occurred. According to the present embodiment, the status display field 701 displays a possible cause of the error (that is, displays a message that the cartridge may have been used by a plurality of image forming devices) and the event that may occur. The displayed message is only an example, and any message may be displayed. The close button 702 is a button for closing the installed device count exceeded error screen 700. When the close button 702 is pressed, the CPU 111 determines that the user has confirmed the screen and terminates displaying the screen. The screen illustrated in FIG. 7A may include a button to clear the training data used to estimate the remaining days. In this case, it is desirable to display an additional message in the status display field 701 (for example, “To improve the estimation accuracy, clear the training data.”).

FIG. 7B illustrates an example according to the present embodiment of an error screen displayed on the operation unit 116 when the cartridge error information displayed in S610 is “cartridge memory not installed error.”

While the present embodiment is described with reference to the error screen displayed on the liquid crystal display unit of the touch panel of the operation unit 116, the error screen may be displayed on another display unit.

A cartridge memory not installed error screen 703 includes a status display field 704 and a close button 705. The status display field 704 displays the cause and description of the error that occurred. According to the present embodiment, the status display field 704 displays a message indicating the inability to communicate with the cartridge memory, the resulting event, and the solution to the inability. The displayed message is only an example, and any message may be displayed. The close button 705 is used to close the cartridge memory not installed error screen 703. When the close button 705 is pressed, the CPU 111 determines that the user has confirmed the screen and terminates displaying the screen.

An error screen according to the present embodiment displayed on the operation unit 116 when, in S610, the cartridge error information is “other cartridge error” is illustrated in FIG. 7C.

While the present embodiment is described with reference to the error screen displayed on the liquid crystal display unit of the touch panel of the operation unit 116, the error screen may be displayed on another display unit.

A cartridge memory not installed error screen 706 includes a status display field 707 and a close button 708. The status display field 707 displays the cause and description of the error that occurred. According to the present embodiment, the status display field 707 displays a message indicating that a cartridge that cannot be supported is currently installed and the solution to the problem. The displayed message is only an example, and any message may be displayed. The close button 708 is a button for closing the cartridge memory not installed error screen 706. When the close button 708 is pressed, the CPU 111 determines that the user has confirmed the screen and terminates displaying the screen.

Referring back to FIG. 6, while continuously displaying the error on the operation unit 116 in S610, the CPU 111 determines, in S611, whether the cartridge is replaced. The CPU 111 determines whether the cartridge 5 is replaced based on the ID information 501 in the cartridge memory 125. However, other methods may be to make the determination.

If, in S611, it is determined that cartridge 5 is replaced, the CPU 111 sends, in S612, the cartridge alarm information 800 to the device management server 200 via the communication unit I/F 123. If, in S611, it is determined that the cartridge 5 is not replaced, the CPU 111 does not transmit the cartridge alarm information 800 to the device management server 200. This is because it is highly likely that information equivalent to the information in S612 has already been transmitted to the device management server 200.

While the present embodiment has been described with reference to the cartridge alarm information 800 transmitted to the device management server 200 only when the cartridge 5 is replaced, the configuration is not limited thereto. If the device management server 200 is designed such that no issue occurs even when duplicate information regarding the same cartridge is received, the cartridge alarm information 800 may be transmitted at all times. In addition, for errors that may change the error status during use, even if the cartridge 5 is not replaced, the CPU 111 may transmit the cartridge alarm information 800 to the device management server 200 when the error status changes.

By transmitting the cartridge alarm information 800 to the device management server 200 in this manner, a service engineer receiving the information can be notified of the possibility of inaccurate estimation of remaining days of the cartridge in addition to the user. This enables the service engineer to perform maintenance in a timely manner. For example, the service engineer who learns that an “installed device count exceeded error” has occurred can visit the user of the image forming device 100 and reset the training data used to estimate the remaining days by using a mode dedicated to the service engineer. After resetting the training data, the service engineer can provide guidance about the usage to the user, which reduces the degradation of estimation accuracy.

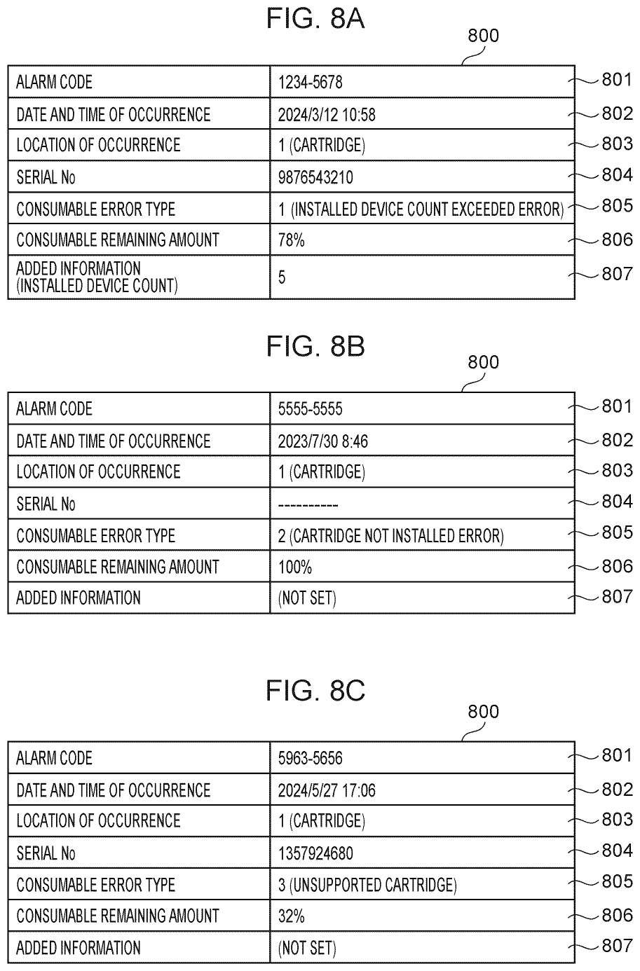

FIGS. 8A to 8C illustrate examples of cartridge alarm information 800 according to the present embodiment. The definitions of the items and values are only examples and are not limited thereto.

FIG. 8A illustrates the example when the cartridge error information is “installed device count exceeded error.” An alarm code 801 indicates the type of alarm. According to the present embodiment, the alarm code 801 is expressed as a combination of eight digits. The alarm code “1234-5678” is used only for the “installed device count exceeded error” and, thus, the service engineer can identify that an “installed device count exceeded error” has occurred via the alarm code. Instead of using the alarm code, the text “installed device count exceeded error” may be used. Date and time of occurrence information 802 indicates the date and time when the error occurred, which is the year, month, day, hour, and minute information, according to the present embodiment. In the example illustrated in FIG. 8A, the date and time of occurrence information 802 is “2024 Mar. 12 10:58.” Location of occurrence information 803 indicates the location where the error occurred and the cause of the error. According to the present embodiment, “1” represents a cartridge.

Serial No information 804 is a unique ID for identifying the cartridge 5 and is the same as the ID information 501. According to the present embodiment, the serial No information 804 is a character string representing a 10-digit number. A character string is used because when, in FIG. 8B, the cartridge error information is “cartridge not installed error,” it is desirable that the serial No information 804 be set as a character string.

Consumable error type information 805 indicates the type of error of the consumable and is set to the same value as the value set in S603, S606, S608, or S609. In the case of “installed device count exceeded error,” “1” is set. Remaining amount of consumable information 806 is a value indicating the remaining amount of the consumable. According to the present embodiment, the remaining amount of consumable information 806 is set to the same value as the remaining amount information 504. Added information 807 is additional information that varies with the type of alarm. According to the present embodiment, in the case of “installed device count exceeded error”, the installed device count information 509 is saved as the installation count. This enables a user of the device management server 200 who receives the alarm to be notified of the specific number of devices in which the cartridge 5 has been installed.

FIG. 8B illustrates an example of the cartridge alarm information 800 when the cartridge error information is “cartridge not installed error.” Only the differences from FIG. 8A are described herein. The alarm code 801 is “5555-5555”, which is unique for this error. In this case, the cartridge memory 125 cannot be accessed. Therefore, according to the present embodiment, the serial number information 804 is set to the character “−” for all 10 digits, which indicates that the information is not acquired. The consumable error type information 805 is set to “2,” which indicates a “cartridge not installed error.” In the case illustrated in FIG. 8B, the added information 807 is not set, and no information is added.

FIG. 8C illustrates an example of the cartridge alarm information 800 when the cartridge error information is “other cartridge error.” Only the differences from FIGS. 8A and 8B are described herein. The alarm code 801 is “5963-5656,” which is a shared alarm code for a plurality of “other cartridge errors.” The consumable error type information 805 is set to “3,” indicating an “unsupported cartridge.” For the cartridge 5 with a “life-expired cartridge” error, the consumable error type information 805 is set to “4,” indicating a “life-expired cartridge.” The cartridge alarm information 800 is transmitted using the same alarm code 801 of “5963-5656.” Upon receipt of the cartridge alarm information 800, the device management server 200 references the consumable error type information 805 to identify the error type for the cartridge 5.

By performing the above-described control, an alarm can be displayed on the operation unit 116 for the user when the cartridge 5 has been installed in a plurality of image forming devices 100. At the same time, the cartridge alarm information 800 can be transmitted to the device management server 200 to notify the device management server 200 that the cartridge 5 is a cartridge that has been installed in a plurality of image forming devices 100 and the number of devices in which the cartridge has been installed. By notifying the device management server 200 that the installed cartridge 5 has been used in a plurality of image forming devices 100 in a shared manner, the possibility of degradation of the estimation accuracy of the remaining days until the end of the installed cartridge's 5 service life can be notified to both the user and a service engineer.

### Second Embodiment

In the first embodiment, the issue is that when one cartridge is used in a plurality of image forming devices (for example, image forming devices A, B, and C) in a shared manner, there is the possibility of degradation of the estimation accuracy of the remaining days until the end of its service life. The first embodiment addresses this issue by counting the number of the image forming devices 100 in which the cartridge 5 has been installed (the installed device count information 509) and notifying the user and/or the service engineer of an error indicating that the count is greater than a predetermined threshold value.

However, if the toner in a cartridge is depleted, the cartridge refilled with toner having different properties than the original toner, and then reused in the same image forming device, the number of devices in which the cartridge has been installed remains unchanged. In this case, the accuracy of estimation of the remaining days until the end of its service life may be degraded. In addition, if a cartridge is repeatedly refilled with toner having different properties from those guaranteed by the manufacture and is reused, elements of the cartridge, such as the photoconductive drum 1 and the developing roller 3, may deteriorate or reach the end of their service life earlier than originally expected.

A second embodiment will not be described that addresses this issue. The following description will focus on the differences from the above-described first embodiment. According to the second embodiment, installation count information 909 is used instead of the first embodiment's installed device count information 509.

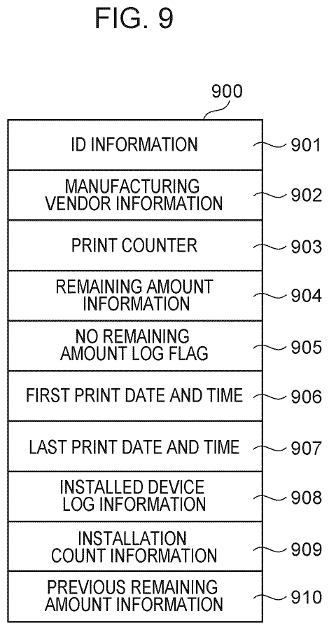

FIG. 9 illustrates an example of cartridge management information 900 stored in the cartridge memory 125 of a cartridge 5 according to the second embodiment.

Information 901 to information 908 in FIG. 9 are the same as the information 501 to the information 508 in FIG. 5, respectively, and, therefore, description is omitted. The installation count information 909 indicates the number of times the cartridge 5 has been installed in the image forming device 100. According to the present embodiment, in the case where the cartridge 5 is installed, if the remaining amount information 904 increases significantly beyond the sensor's error before and after the cartridge 5 is installed (for example, if the remaining amount increases by 50% or more), the installation count information 909 is increased by one.

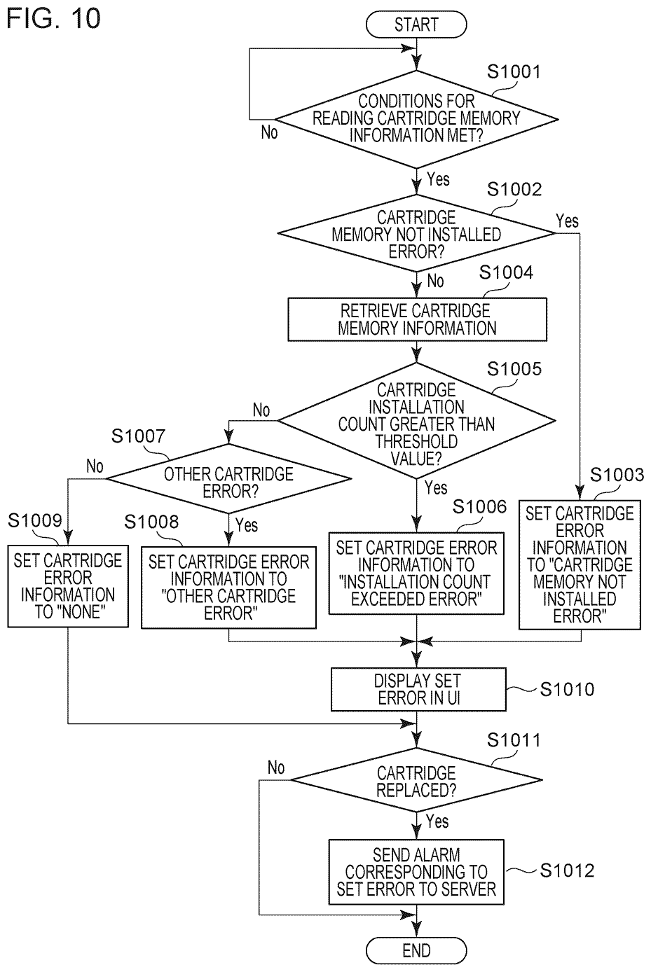

Previous remaining amount information 910 is a saved value of the remaining amount information 904 before the cartridge 5 is uninstalled from the image forming device 100. When the cartridge 5 is installed, the previous remaining amount information 910 is compared with the remaining amount information 904 to determine whether the installation count information 909 has increased. At this time, the installation count information 909 may be simply the number of times the cartridge 5 is installed, without accounting for the change in the remaining amount information 904. In this case, since the installation count information 909 is increased even when the cartridge 5 is simply uninstalled and, then, installed, a threshold value used in S1005 of FIG. 10 (described below) needs to be a relatively large value determined while accounting for the increase.

FIG. 10 is a flowchart of a cartridge error determination process performed by the image forming device 100 according to the present embodiment. The processing illustrated in the flowchart in FIG. 10 is performed by the CPU 111 of the image forming device 100 that loads the program stored in the ROM 112 into the RAM 113 and executes the loaded program.

Processes in S1001 to S1003 and S1007 to S1012 illustrated in FIG. 10 are the same as the processes in S601 to S603 and S607 to S612 illustrated in FIG. 6, respectively. Therefore, descriptions of these processes are omitted.

If, in S1002, it is determined that a “cartridge memory not installed” error has not occurred, the CPU 111 instructs, in S1004, the print unit 120 to retrieve the cartridge management information 900 via the print unit I/F 119. Then, the print unit 120 reads the information from the cartridge memory 125 and writes the information into the RAM 113 so that the CPU 111 can refer to the information. In S1005, the CPU 111 refers to the installation count information 909 contained in the acquired cartridge management information 900 and determines whether the number of times the cartridge 5 has been installed is greater than a predetermined threshold value. According to the present embodiment, the threshold value is set to 3, for example, because the installation count information 909 is increased while accounting for a change in the remaining amount information 904. That is, if the installation count information 909 is greater than or equal to 4, it is determined that the number of times the cartridge 5 has been installed is greater than the predetermined threshold value. At this time, if a change in the remaining amount information 904 is not accounted for, it is desirable that the threshold value be set to a value larger (for example, 15) than that when the change is accounted for. If, in S1005, it is determined that the number of times the cartridge 5 has been installed is greater than the predetermined threshold value, the CPU 111 sets, in S1006, the cartridge error information in the RAM 113 to “installation count exceeded error.”

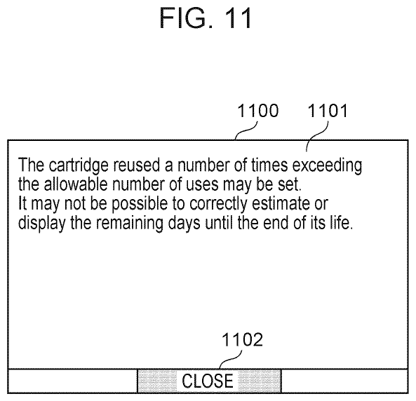

FIG. 11 illustrates an example of an error screen displayed when an “installation count exceeded error” occurs according to the present embodiment. The installation count exceeded error screen 1100 includes a status display field 1101 and a close button 1102. The status display field 1101 is similar to the status display field 701, but the displayed message is a message corresponding to the “installation count exceeded error.” The close button 1102 is the same as the close button 702.

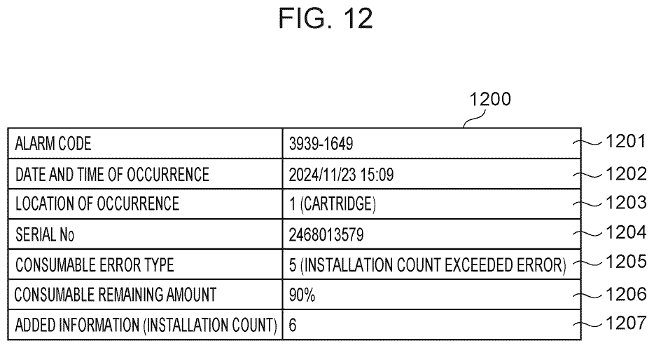

FIG. 12 illustrates an example of cartridge alarm information 1200, where the cartridge error information is “installation count exceeded error.” The cartridge alarm information 1200 is similar to the cartridge alarm information 800 illustrated in FIG. 8A, and the differences from FIG. 8A are described below.

An alarm code 1201 is “3939-1649” that is used only for the “installation count exceeded error.” Consumable error type information 1205 is set to “5,” which indicates an “installation count exceeded error.” In the case of an “installation count exceeded error,” the installation count information 909 is stored in added information 1207 as the installation count.

By performing the above-described control, an alarm can be displayed on the operation unit 116 for the user when the cartridge 5 is repeatedly refilled with toner and then reused. The cartridge alarm information 1200 can be transmitted to the device management server 200 to notify the device management server 200 that the cartridge 5 is a cartridge that is repeatedly refilled with toner and reused. The number of times the cartridge 5 has been reused can be transmitted as the installation count.

The above-described control cannot detect the properties of the re-filled toner. However, if the manufacturer of the image forming device 100 and the cartridge 5 remanufactures the cartridge, the number of times the cartridge has been reused can be obtained by referring to the installation count information 909 in the cartridge memory 125. Then, if the number of times the cartridge has been reused reaches the manufacturer's recommended limit, the cartridge is discarded rather than being remanufactured. Thus, the cartridge remanufactured by the manufacturer does not cause an “installation count exceeded error.” The occurrence of an “installation count exceeded error” indicates that the cartridge was refilled with toner manufactured by a manufacturer other than the manufacturer of the image forming device 100 and the cartridge 5, and the properties of the toner may be different from those of the original toner. Saving and utilizing the installation count information 909 in this way enables detecting the possibility that the cartridge has repeatedly been refilled with toner having properties that differ from those guaranteed by the manufacturer and reused.

In the above description of the “installed device count exceeded error” in the first embodiment and the “installation count exceeded error” in the second embodiment, only one of these two errors occurs in each of the embodiments. If the cartridge management information contains both the installed device count information 509 and the installation count information 909, both errors can be detected and notified, and such a configuration may be employed.

According to the present disclosure, the user can be notified of the occurrence of a situation in which, as a result of using a recording material storage unit in a plurality of image forming devices, sufficient training data cannot be acquired and, thus, the accuracy of estimation of the remaining days of the recording material storage unit is degraded.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-192849, filed Nov. 1, 2024, which is hereby incorporated by reference herein in its entirety.

What is claimed is:

1. An image forming device comprising:
a recording material storage unit that includes a storage unit;
at least one memory that stores a program; and
at least one processor that causes, by executing the program, the image forming apparatus to:
acquire, from the storage unit, a number of devices in which the recording material storage unit has been installed; and
provide a predetermined notification based on the acquired number of devices.

2. The image forming device according to claim 1, wherein the predetermined notification is provided if the acquired number of devices is greater than a predetermined value, and
wherein the predetermined notification is not provided if the acquired number of devices is less than or equal to the predetermined value.

3. The image forming device according to claim 1, wherein if the recording material storage unit was previously installed in the image forming device, the number of devices stored in the storage unit is not increased, and
wherein if the recording material storage unit is newly installed in the image forming device, the number of devices stored in the storage unit is increased.

4. The image forming device according to claim 1, wherein, based on the acquired number of devices, predetermined information is sent to an external device.

5. The image forming device according to claim 1, wherein the storage unit stores information indicating a remaining amount of recording material contained in the recording material storage unit.

6. The image forming device according to claim 1, wherein the storage unit stores a number of sheets having had an image formed on the sheet using a recording material contained in the recording material storage unit.

7. A method for controlling an image forming device including a recording material storage unit that includes a storage unit, the method comprising:
acquiring, from the storage unit, a number of devices in which the recording material storage unit has been installed; and
providing a predetermined notification based on the acquired number of devices.

8. A non-transitory computer-readable storage medium storing one or more control programs that cause an image forming device including a recording material storage unit that includes a storage unit to execute a method, the method comprising:
acquiring, from the storage unit, a number of devices in which the recording material storage unit has been installed; and
providing a predetermined notification based on the acquired number of devices.
